(19) United States
(12) Patent Application Publication
(10) Pub. No.: US 2025/0306977 A1
(43) Pub. Date: Oct. 2, 2025

(54) METHOD FOR OPERATING A MOTOR VEHICLE

(71) Applicants: Robert Bosch GmbH, Stuttgart (DE); CARIAD SE, Wolfsburg (DE)

(72) Inventors: Jens BREITBART, Wildeck (DE); Stefan KUMMLER, Pleidelsheim (DE)

(21) Appl. No.: 19/097,334

(22) Filed: Apr. 1, 2025

(30) Foreign Application Priority Data
Apr. 2, 2024 (DE) 102024109201.7

(51) Int. Cl. G06F 9/455

(52) U.S. Cl. CPC G06F 9/45558

(57) ABSTRACT

A method for operating a motor vehicle include providing, at a computer system of the motor vehicle, at least one main application for operating the motor vehicle. The method includes subdividing, using a virtualization, the computer system into at least one virtual main function part and at least one virtual additional function part. The method also includes executing, using the at least one virtual main function part, the at least one main application. The method includes providing at least one validation application configured to validate a function of the motor vehicle. The method further includes executing, using the at least one virtual additional function part, the at least one validation application.

### CROSS-REFERENCE TO RELATED APPLICATION

This application claims priority to German Patent Application No. DE102024109 201.7, filed on Apr. 2, 2024, the contents of which is hereby incorporated by reference in its entirety.

### TECHNICAL FIELD

The present invention relates to a method for operating a motor vehicle having a computer system, by means of which at least one main application for operating a motor vehicle is carried out. In addition, the invention relates to a computer programme product for carrying out the method.

### BACKGROUND

In a motor vehicle, applications for operating the motor vehicle are usually employed. In the motor vehicle, such applications can each implement a function or be part of a function, which is required for operating the motor vehicle. For running such applications, motor vehicles generally comprise a computer system with suitable hardware.

To improve functions and/or for introducing new functions, a validation of the new or modified functions is usually necessary. Usually, such changes are provided in the form of suitable applications that are to be validated.

US 2021/382 756 A1 describes a method for the static partitioning of a hardware accelerator in a cloud in such a manner that the partitions do not mutually influence one another.

From US 2019/02 866 07 A1, the joint utilisation of a storage device is known. This allows writing data from different sources to the storage device at the same time.

WO 2021/179 780 A1 describes a method for the dynamic shifting of resources between virtual graphic processors of a computer system. This allows providing the graphic processors to multiple clients for use.

### SUMMARY

The present invention deals with the object of showing new, in particular improved or other ways for a method for operating a motor vehicle and for a computer programme product for carrying out the method.

This object is achieved with the independent claims. Advantageous methods are subject of the dependent claims.

The subject of the invention accordingly is the use of the same computer system of a motor vehicle for running applications for functions required during the operation of the motor vehicle, in the following also referred to as main applications, and for the validation of modified and/or new functions, in the following also referred to as validation applications. In the process, a virtualisation is employed in order to subdivide the computer system in virtual parts that are separated from one another for running the main applications on the one hand and for running the validation applications on the other hand. As a consequence, a substantial saving of costs and resources as well as energy occurs, for example, compared with the provision of in each case own computer systems for running the main applications and the validation applications. Separating the running of the main applications and of the validation applications by means of the virtualisation further results in avoiding undesirable mutual influencing of the main applications and of the validation applications, so that the method at the same time has no influence on the operation of the motor vehicle. The latter results in increased safety. Both advantages with respect to the saving of costs and resources and also advantages for increased safety are achieved with the invention.

Thus, the invention relates to a method for operating a motor vehicle. For operating the motor vehicle, a main application is initially run. In the process, the motor vehicle comprises a computer system, by means of which at least one such main application is run. In addition, a validation application for validating a function of the motor vehicle is provided. According to the invention, the computer system is subdivided by means of virtualisation into at least one virtual function part for at least one main application and at least one virtual function part for the validation application. The respective function part for the main application is also referred to as main function part and the respective function part for the validation application is also referred to as additional function part in the following. The at least one main application is run by means of the at least one main function part. In addition, the validation application is exclusively run by means of the at least one additional function part.

The subdivision of the computer system run by means of the virtualisation into the at least one main function part and the at least one additional function part takes place in such a manner that the at least one main function part is separated from the at least one additional function part. This means that preferably no mutual influencing of the at least one main function part and of the at least one additional function part occurs.

The exclusive running of the validation application by means of the at least one additional function part here is to mean that the validation application is run without the at least one main function part.

The respective main application can be software of any kind with which a function for operating the motor vehicle is at least partially run. This includes, for example, the operating system as well as firmware and the like.

The provision of the validation application can take place in any way. For example, the validation application can be transferred to the motor vehicle by means of data communication via an external source, in particular wirelessly.

It is conceivable to provide the validation application in the form of an update or of an upgrade. The update or upgrade is validated in the vehicle as described here and, upon successful validation, can subsequently become the main application.

A computer system in terms of the present invention preferentially includes all hardware required for running the applications. In particular, the computer system, besides a computer unit, can comprise at least one memory, accelerator and the like.

The computer system can comprise, for example, a system-on-a-chip or “SoC” in brief or comprise at least one SoC.

For example, the computer system can comprise at least one hardware accelerator which is subdivided by means of virtualisation. This means that the at least one hardware accelerator forms or can be a part of at least one such virtual main function part and a part of at least one such virtual additional function part.

At least one of the at least one hardware accelerators can advantageously be or comprise an AI accelerator, wherein “AI” stands for “artificial intelligence”. The AI accelerator can comprise a neuromorphic processor or be a neuromorphic processor.

Likewise, at least one of the at least one hardware accelerators can include at least one graphic processor or consist of at least one graphic processor.

Preferably, the visualisation is carried out in such a manner that all hardware of the computer system and/or all available resources of the computer system as described here is/are subdivided in the virtual function parts and thus form parts of the respective function part.

The subdivision of the computer system by means of virtualisation can basically take place dynamically. In this case, the at least one main function part and the at least one additional function part are provided with more or less resources of the computer system by means of virtualisation depending on requirement.

In preferred embodiments, the computer system is statically subdivided into the at least one main function part and the at least one additional function part. This means that the resources of the computer systems are statically assigned by means of virtualisation to the at least one main application and the validation application. Thus, the at least one main application and the validation application are also guaranteed a minimum of the resources, so that in particular the at least one main function part can be reliably and predictably run. This results in an improved operation of the motor vehicle with increased safety.

The subdivision of the computer system by means of virtualisation preferentially takes place in such a manner that adequate resources of the computer system are provided to the at least one main application for the smooth execution. This results in a further increase of the safety.

Advantageously, the computer system is subdivided by means of virtualisation in such a manner that the at least one main function part is assigned more resources than the at least one additional function part.

In advantageous variants, the computer system is subdivided by means of virtualisation in such a manner that the at least one main function part is assigned at least twice as many resources as the at least one additional function part. For example, the at least one main function part can be assigned two-thirds and the at least one additional function part one-third of the resources.

Preferred are variants, in which a hypervisor is provided. The hypervisor includes at least one virtual machine for the at least one main application and at least one virtual machine for the validation application. The respective at least one virtual machine for the main application is also referred to as main virtual machine and the at least one virtual machine for the validation application also as additional virtual machine in the following. Thus, the hypervisor includes at least one main virtual machine and at least one additional virtual machine. The at least one main virtual machine is assigned to the at least one main function part and separated from the at least one additional function part. In addition, the at least one additional virtual machine is assigned to the at least one additional function part and separated from the at least one main function part. The at least one main application is run in the at least one main virtual machine and the validation application in the at least one additional virtual machine. Thus, there is a further clear separation between the running of the respective main application and of the validation application. Besides a more reliable operation, this results in a further increased safety.

Preferably, the hypervisor is connected to the function parts in a data-communicating manner such that data communication between the respective main function part and the associated main virtual machine on the one hand and data communication between the respective additional function part and the associated additional virtual machine on the other hand, takes place. Data communication can take place, for example, by means of a bus.

Practically, the motor vehicle comprises a hardware which during the operation provides, in particular, supplies data for at least one of the at least one main applications. In the following, the hardware is also referred to as application hardware and the provided data also as input data. The application hardware thus generates input data during the operation, which is provided to at least one of the at least one main applications.

Preferably, the input data is at least partially also provided to the validation application. Based on the same input, this makes possible in particular comparing the evaluation and/or execution of the main application and of the validation application for validating the validation application. For example, it can thus be compared if the validation application supplies comparable or better results than the corresponding main application. Accordingly it is preferred when for validating the validation application, results of the validation application are compared with results of at least one of the at least one main applications.

The provision of the input data for the validation application preferably takes place taking into account the partitioning of the resources of the computer system. When, for example, the at least one additional function part is assigned one-third and the at least one main function part two-thirds of the resources, a corresponding proportion of the input data can be provided to the validation application.

The input data can be processed prior to the provision. For example, the input data can be filtered and/or justified and/or converted and/or combined, for example, in the manner of a fusion. Here it is conceivable to perform the processing as part of at least one such main application.

The application hardware can be of any kind.

For example, the application hardware can be a sensor or comprise a sensor, which during the operation provides sensor data as input data.

The sensor can be a camera which, during the operation, provides images and thus image data as input data.

Likewise, the sensor can be a LIDAR sensor, radar sensor or ultrasound sensor.

The application hardware can also comprise two or more such sensors.

In particular, taking into account the resources, for example all sensor data, for example all image data, can be provided to at least one main application and merely a part of the sensor data, for example, a part of the image data, to the validation application.

For subdividing the computer system, any kind of virtualisation can be employed.

For example, the so-called “single root input/output virtualisation” can be employed, which is also known by the abbreviation “SR-IOV”. This means that the computer system can be subdivided by means of SR-IOV into the at least one virtual main function part and the at least one virtual additional function part.

It is to be understood that by means of the method according to the invention two or more validation applications can also be run. This means that by means of the at least one additional function part at least one validation application is run. This also means that upon provision of the hypervisor, the at least one validation application is run on the at least one additional virtual machine.

For carrying out the method, a suitable computer programme product is advantageously employed. The computer programme product as such is likewise part of this invention.

The computer programme product includes commands which, upon execution of the computer programme product by a motor vehicle, cause the motor vehicle to carry out the method.

Further important features and advantages of the invention are obtained from the subclaims, from the drawings and from the associated figure description by way of the drawings.

It is to be understood that the features mentioned above and still to be explained in the following cannot only be used in the respective combination stated, but also in other combinations, or by themselves without leaving the scope of the present invention.

Preferred exemplary embodiments of the invention are shown in the drawings and are explained in more detail in the following description, wherein same reference signs relate to same or similar or functionally same components.

### BRIEF DESCRIPTION OF THE DRAWINGS

It shows, in each case schematically:

FIG. 1 shows a highly simplified diagrammatic representation of a motor vehicle with a computer system,

FIG. 2 shows a diagram for the subdivision of the computer system into virtual function parts, and

FIG. 3 shows a flow diagram for operating the motor vehicle.

### DETAILED DESCRIPTION

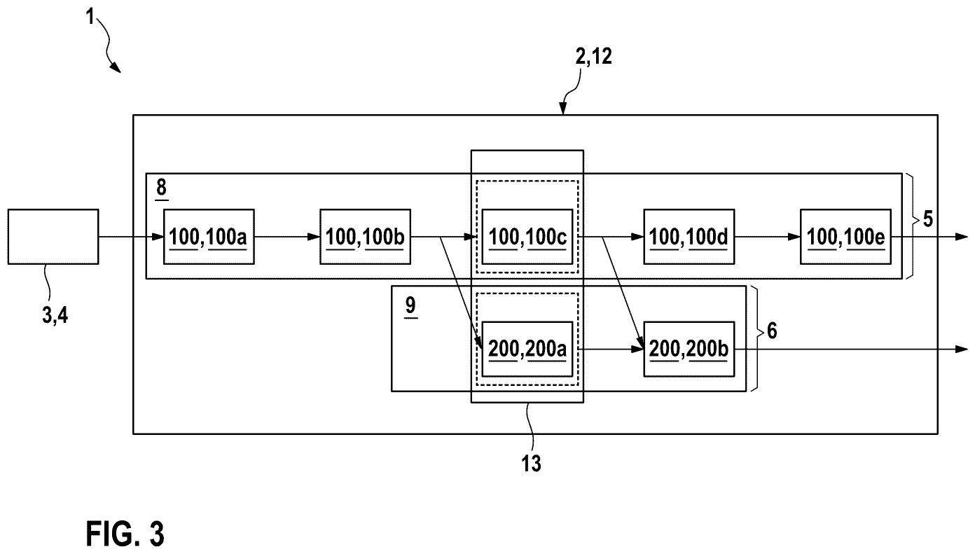

A motor vehicle 1 exemplarily shown in FIG. 1 comprises a computer system 2 for running applications 100, 200 (see FIG. 3). In the exemplary embodiment shown in FIG. 1, data is processed by means of the computer system 2 which the computer system 2 receives from hardware 3 of the motor vehicle 1. In the following, the hardware 3 is also referred to as application hardware 3 and the data also as input data. In the shown exemplary embodiments, the application hardware 3 is purely exemplarily a sensor 4, which during the operation supplies data, for example, of the surroundings of the motor vehicle 1, as input data, i.e. sensor data. In the following, it is purely exemplarily assumed that the sensor 4 is a camera which during the operation provides image data as sensor data and thus input data. By means of the computer system 2, applications 100 are run which are employed for the current operation of the motor vehicle 1. These applications 100 are also referred to as main applications 100 in the following. Thus, the respective main application 100 carries out at least one step of a function required for the current operation of the motor vehicle 1. With the computer system 2, at least one application 200 for validating a function of the motor vehicle 1 is additionally run. The function can be a new function or a modified version of an existing function. This application 200 is also referred to as validation application 200 in the following. The respective at least one validation application 200 can be wirelessly transmitted to the motor vehicle 1 from an external source. Thus, the respective validation application 200 does not serve for the current operation of the motor vehicle 1. With the respective validation application 200, it is to be checked in the shown exemplary embodiment, whether a new function can be introduced or the modification of an existing function be implemented.

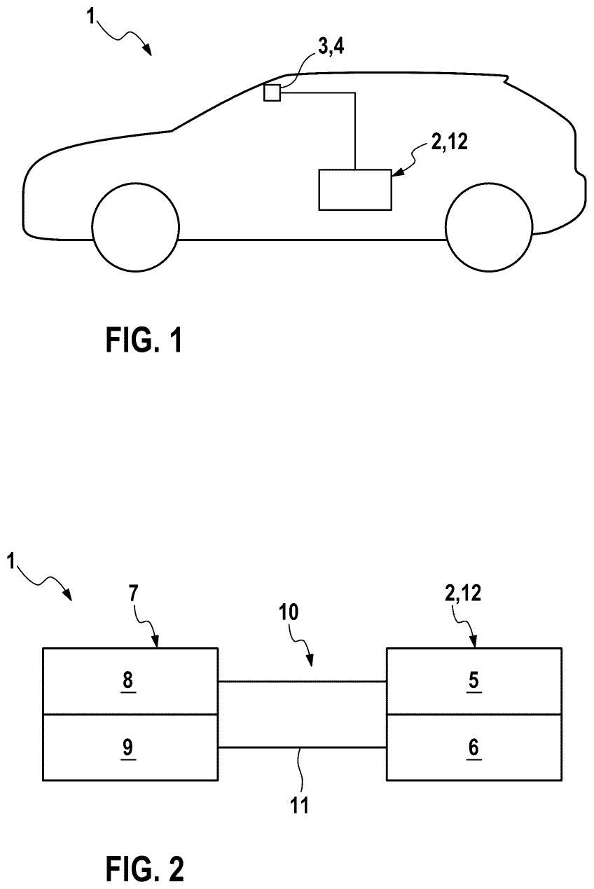

As is shown, for example, in FIG. 2, the computer system 2 for this purpose is subdivided by means of virtualisation into at least one virtual function part 5 for running the at least one main application 100 and at least one virtual function part 6 separated therefrom for running the at least one validation application 200. For example, the computer system is subdivided into the virtual function parts 5, 6 by means of “single root input/output virtualisation”, also known by the abbreviation “SR-IOV”. The respective virtual function part 5 is also referred to as main function part 5 and the respective virtual function part 6 also as additional function part 6 in the following. As is exemplarily explained by way of FIG. 3 in the following, the at least one main application 100 is run by means of the at least one main function part 200 and the at least one validation application 200 by means of the at least one additional function part 200 and without using the at least one main function part 200, i.e. exclusively by means of the additional function part 200.

In the exemplary embodiments shown in the FIGS. 2 and 3, a single main function part 5 and a single additional function part 6 each is purely exemplarily assumed.

In the shown exemplary embodiments, the computer system 2 is statically subdivided into the at least one main function part 5 and the at least one additional function part 6. This means that the resources of the computer system 2 can be statically assigned to the at least one main function part 5 and the at least one additional function part 6. For example, two-thirds of the resources can be statically assigned to the at least one main function part 5 and one-third of the resources can be statically assigned to the at least one additional function part 6. The virtualisation takes place accordingly.

As schematically shown in FIG. 2, a hypervisor 7 is additionally provided in the shown exemplary embodiments, which comprises at least one virtual machine 8 for the at least one main application 100 and at least one virtual machine 9 for the at least one validation application 200. The respective at least one virtual machine 8 for the at least one main application 100 is also referred to as main virtual machine 8 and the respective at least one virtual machine 9 for the validation application 200 also as additional virtual machine 9 in the following. In the shown exemplary embodiments, a single main virtual machine 8 and a single additional virtual machine 9 are purely exemplarily assumed. The main virtual machine 8 is assigned to the main function part 5 and separated from the at least one additional function part 6. This means that the resources of the additional function part 6 are not available to the main virtual machine 8. In addition, the additional virtual machine 9 is assigned to the additional function part 6 and separated from the main function part 5. This means that the resources of the main function part 5 are not available to the additional virtual machine 9. As is evident from FIG. 3, the at least one main application 100 is run in the main virtual machine 8 and the at least one validation application 200 in the additional virtual machine 9. As indicated in FIG. 2, a data communication 10 takes place between the main virtual machine 8 and the main function part 5 as well as between the additional virtual machine 9 and the additional function part 6. As indicated in FIG. 2, the data communication 10 can take place by means of a bus 11.

In the shown exemplary embodiments, the computer system 2 is purely exemplarily a system-on-a-chip 12 or “SoC” 12 in brief. In the shown exemplary embodiments, the SoC 12 comprises a hardware accelerator 13. The hardware accelerator 13 exemplarily includes an AI accelerator (not shown), which, for example, comprises a neuromorphic processor (not shown), or is such an AI accelerator. In the exemplary embodiment shown in FIG. 3, the hardware accelerator 13 is likewise subdivided by means of virtualisation and thus comprises a virtual part as constituent part of the main function part 5 and a virtual part as constituent of the additional function part 6. The SoC 12 can additionally comprise a control device or “ECU” in brief and/or accelerators and/or memories, each of which are not shown and are likewise subdivided by means of virtualisation as described. In the shown exemplary embodiments, both the main virtual machine 8 and also the additional virtual machine 9 are run in the SoC 12.

FIG. 3 shows an exemplary operation of the motor vehicle 1 with regard to the input data provided by the application hardware 3 during the operation. In the shown exemplary embodiment, the camera 4 is thus assumed as application hardware, which during the operation provides images and thus image data as input data.

As indicated in FIG. 3, the image data is supplied to a main application 100, 100a, by means of which a conversion of the image data present as raw data takes place. The main application 100, 100A is also referred to as conversion application 100, 100A in the following. The image data converted by means of the conversion application 100, 100A is supplied to a main application 100, 100b which carries out an equalisation of the images. This main application 100, 100b is also referred to as equalisation application 100, 100b in the following. Thus, processing and/or preparation of the image data take/s place with the conversion application 100, 100a and the equalisation application 100, 100b. The image data thus processed or prepared is supplied to a main application 100, 100c and a validation application 200, 200a, which are run by means of the appropriate constituent parts of the hardware accelerator 13. With the main application 100, 100c, objects in the images are detected by means of the virtual part of the hardware accelerator 13 belonging to the main function part 5. The main application 100, 100c is also referred to as detection application 100, 100c in the following. In addition, objects in the images are likewise detected with the validation application 200, 200a by means of the virtual part of the hardware accelerator 13 belonging to the additional function part 6. In the shown exemplary embodiment, the validation application 200, 200a represents, for example, a modified version of the detection application 100, 100c. The validation application 200, 200a is thus exemplarily an update or an upgrade of the detection application 100, 100c. In the following, the validation application 200, 200a is also referred to as update application 200, 200a. Based on the different distribution of the resources it is possible to make available to the update application 200, 200a merely a part of the processed and/or prepared image data. For example, it is conceivable to provide each third processed and/or prepared image to the update application 200, 200a and all to the detection application 100, 100c. The objects detected by means of the detection application 100, 100c are provided to a main application 100, 100d. With the main application 100, 100d, a fusion and tracking of the detected objects can take place, for example. In the following, the main application 100, 100d is also referred to as tracking application 100, 100d. The objects detected by means of the update application 200, 200a are provided to a validation application 200, 200b. In addition, the objects detected by means of the detection application 100, 100c are provided to the validation application 200, 200b. In the validation application 200, 200b, a comparison of the results of the update application 200, 200a with corresponding results of the detection application 100, 100c takes place. By means of this comparison, it can then be evaluated whether the update application 200, 200a is approved as a future main application 100, i.e., for example, as a future detection application 100, 100c. The validation application 200, 200b is also referred to as evaluation application 200, 200b in the following.

In the shown exemplary embodiment, the results of the tracking application 100, 100d are provided to a main application 100, 100e. The main application 100, 100e can be a constituent part of a driver assistance of the motor vehicle 1 which is not otherwise shown and is also referred to as assistance application 100, 100e in the following. By means of the assistance application 100, 100e, an autonomous braking function of the motor vehicle I can be performed, for example.

The method is exemplarily run with a computer programme product, including corresponding commands.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first clement could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the phrase at least one of successive elements separated by the word “and” (e.g., “at least one of A and B”) is to be interpreted the same as the term “and/or” and as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

1. A method for operating a motor vehicle, the method comprising:
providing, at a computer system of the motor vehicle, at least one main application for operating the motor vehicle;
subdividing, using a virtualization, the computer system into at least one virtual main function part and at least one virtual additional function part;
executing, using the at least one virtual main function part, the at least one main application;
providing at least one validation application configured to validate a function of the motor vehicle; and
executing, using the at least one virtual additional function part, the at least one validation application.

2. The method according to claim 1, wherein the computer system is statically subdivided into the at least one virtual main function part and the at least one virtual additional function part.

3. The method according to claim 1, wherein the computer system is subdivided using the virtualization such that the at least one virtual main function part is assigned with more resources of the computer system than the at least one virtual additional function part.

4. The method according to claim 1, wherein the computer system is subdivided using the virtualization such that the at least one virtual main function part is assigned with at least twice as many resources of the computer system than the at least one virtual additional function part.

5. The method according to claim 1, further comprising:
providing a hypervisor, the hypervisor including at least one main virtual machine and at least one additional virtual machine;
assigning the at least one main virtual machine to the at least one virtual main function part and separating the at least one main virtual machine from the at least one virtual additional function part;
assigning the at least one additional virtual machine to the at least one virtual additional function part and separating the at least one additional virtual machine from the at least one virtual main function part; and
executing the at least one main application in the at least one main virtual machine and executing the at least one validation application in the at least one additional virtual machine.

6. The method according to claim 1, further comprising:
providing an application hardware in the motor vehicle, the application hardware is configured to generate input data during operation;
providing the input data to at least one of the at least one main application; and
providing at least portion of the input data to at least one of the at least one validation applications.

7. The method according to claim 6, wherein the application hardware comprises at least one sensor configured to provide sensor data as the input data.

8. The method according to claim 6, wherein a validation is performed by comparing results of at least one of the at least one validation applications with results of at least one of the at least one main applications.

9. The method according to claim 1, wherein the computer system comprises at least one hardware accelerator, the at least one hardware accelerator is subdivided using the virtualization such that a first portion of the at least one hardware accelerator is allocated to the at least one virtual main function part and a second portion is allocated to the at least one virtual additional function part.

10. The method according to claim 1, wherein the computer system is subdivided into the at least one virtual main function part and the at least one virtual additional function part using single root input/output virtualization.

11. A non-transitory, tangible computer-readable storage medium on which computer readable instructions of a program are stored, the instructions, when executed by a processor of a motor vehicle, cause the processor to perform a method, the method comprising:
subdividing, using a virtualization, a computer system of the motor vehicle into at least one virtual main function part and at least one virtual additional function part, the computer system is provided with at least one main application;
executing, using the at least one virtual main function part, the at least one main application;
providing at least one validation application configured to validate a function of the motor vehicle; and
executing, using the at least one virtual additional function part, the at least one validation application.

12. The non-transitory, tangible computer-readable storage according to claim 11, wherein the computer system is statically subdivided into the at least one virtual main function part and the at least one virtual additional function part.

13. The non-transitory, tangible computer-readable storage according to claim 11, wherein the computer system is subdivided using the virtualization such that the at least one virtual main function part is assigned with more resources of the computer system than the at least one virtual additional function part.

14. The non-transitory, tangible computer-readable storage according to claim 11, wherein the computer system is subdivided using the virtualization such that the at least one virtual main function part is assigned with at least twice as many resources of the computer system than the at least one virtual additional function part.

15. The non-transitory, tangible computer-readable storage according to claim 11, further comprising:
providing a hypervisor, the hypervisor including at least one main virtual machine and at least one additional virtual machine;
assigning the at least one main virtual machine to the at least one virtual main function part and separating the at least one main virtual machine from the at least one virtual additional function part;
assigning the at least one additional virtual machine to the at least one virtual additional function part and separating the at least one additional virtual machine from the at least one virtual main function part; and
executing the at least one main application in the at least one main virtual machine and executing the at least one validation application in the at least one additional virtual machine.

16. The non-transitory, tangible computer-readable storage according to claim 11, further comprising:
providing input data to at least one of the at least one main application; and
providing at least portion of the input data to at least one of the at least one validation applications,
wherein an application hardware, in the motor vehicle, generates the input data during operation.

17. The non-transitory, tangible computer-readable storage according to claim 16, wherein the application hardware comprises at least one sensor configured to provide sensor data as the input data.

18. The non-transitory, tangible computer-readable storage according to claim 16, wherein a validation is performed by comparing results of at least one of the at least one validation applications with results of at least one of the at least one main applications.

19. The non-transitory, tangible computer-readable storage according to claim 11, wherein the computer system comprises at least one hardware accelerator, the at least one hardware accelerator is subdivided using the virtualization such that a first portion of the at least one hardware accelerator is allocated to the at least one virtual main function part and a second portion is allocated to the at least one virtual additional function part.

20. The non-transitory, tangible computer-readable storage according to claim 11, wherein the computer system is subdivided into the at least one virtual main function part and the at least one virtual additional function part using single root input/output virtualization.
